(19) United States
(12) Patent Application Publication
(10) Pub. No.: US 2008/0162169 A1
(43) Pub. Date: Jul. 3, 2008

(54) Passenger air transport freed of terrorist threats in transit

(76) Inventor: William Eugene Hodge, Lumby (CA)

Correspondence Address: William E. Hodge, 1939 Saddleview Avenue, PO Box 287, Lumby, BC, VOE 2G0, omitted

(21) Appl. No.: 11/812,723

(22) Filed: Jun. 21, 2007

Related U.S. Application Data
(60) Provisional application No. 60/837,628, filed on Aug. 15, 2006.

(51) Int. Cl. G06Q 10/00

(52) U.S. Cl. 705/1

(57) ABSTRACT

A method is given for an efficient and effective means of eliminating the possibility that civilian airline passenger belongings could be used as an opportunity for terrorists to kill passengers in transit. The essence of this method is to arrange for the passengers' baggage and personal transit articles to be conveyed to the destination in a separate aircraft from the one in which the people travel. There are two levels of caution, with the ultimate level of certainty requiring passengers to change into flight suits provided to them at the airport by security staff.

### BACKGROUND OF THE INVENTION

1. Field of Invention

The method and apparatus is intended to provide safety for people and aircraft engaged in normal civilian air travel. The primary purpose is to remove the threat of terrorist damage to the carrier in transit and also to improve and facilitate the whole checking-in process at minimum added inconvenience to the passengers and airport staff.

2. Description of Related Art

### Current Practice

Current practice, which is a well known routine to air travelers, involves three separate security steps before boarding: It starts at the check-in counter with the passenger giving a verbal declaration to the airline representative attesting to the contents of the heavier pieces of luggage to be taken by the airport staff from the counter and then loaded, without further detailed inspection, into the cargo bay of the same aeroplane on which the passengers will be carried to their destination. The carry-on luggage is subjected to limited inspection before the passenger enters the departure lounge. The passenger's body and clothing is also subjected to further checking for metallic objects. The personnel performing this crucial examination are in many airports are neither highly paid or highly trained.

The airport staff is generally allowed to wander around the departure area in contact with passengers even after all screening is considered complete.

Problems with Current Practice

The checked-in baggage could contain a fully assembled bomb timed to detonate at a predetermined altitude or time. The carry-on baggage could contain the elements of a deleterious device, such as an explosive or toxic gas fumigator, which could be assembled during flight from apparently benign parts, so as to destroy the aircraft or incapacitate the pilots during flight. And passengers themselves could, by disguising deleterious artifacts, bring on board as parts of their clothing and personal items similar tools and substances. At present a search sufficiently thorough to expose such threats would lead to a great deal of added airport expense in order to hire the greater numbers of more highly trained security staff required to expend more time and effort on each examination. This would in turn add a great deal of inconvenience to the passengers, and require their earlier attendance at the airport, with the consequent increase in non-productive time on their part.

### SUMMARY OF THE INVENTION

### Disclosure of the Invention

### Description of Method

The essential element of the invention is the complete separation of passengers from their transit personal possessions and luggage, and to have those items transported to the flight destination in a craft entirely independent from that in which the passengers themselves travel. In order that passengers are not obliged to wait longer than normal to recover transit belongings it is necessary that the two separate aircraft fly on about the same schedule. This is most easily accomplished if the cargo craft is an unmanned drone flying on the same flight plan as the passenger airliner.

To make this system functional at the very highest level of certainty and safety new elements need to be introduced to the manner in which airports operate at present, and these are as follows:

Transit clothing, perhaps in the style of a jumpsuit, and one of a range of sizes, would be given to each passenger by the airport security staff and into which passengers would have to change before entering the departure lounge; the clothing worn by the passenger upon arrival at the airport would be deposited by the security staff with that passenger's other baggage. Necessary medication would be supplied by a pharmacist attached to the airport and would be available by prearrangement.

Keeping all of each passenger's or family group's possessions together during transport would be facilitated by a separate secured box designated to each individual passenger. This security box would be made to a standardized set of dimensions sized to meet the aircraft type and airline's baggage load and space allowances per passenger: a family group would be assigned more than one box if necessary. Standardization of security box size would facilitate loading into the cargo aircraft.

Preferably, the cargo aircraft would be of the drone type with no personnel on board; and, if a drone, could be custom designed strictly as a cargo container and optimized to receive only that airline's standardized baggage security boxes. A drone could be similar to a glider and towed by the passenger aircraft at an appropriate separation, and could be jettisoned if reason indicated. Otherwise, the drone could be self-propelled and fly close behind the passenger craft, taking off and landing at essentially the same time.

Otherwise the luggage craft could be a normal piloted cargo plane. And, in the case of a piloted vehicle it would be permissible to have other national security personnel such as immigration and custom officers on board who could do a thorough investigation of luggage/baggage during the flight.

In either case the design of the passenger craft, in the absence of cargo space requirements, could be modified to optimize passenger space or numbers of occupants.

### OBJECTS AND ADVANTAGES

### Improvements Proposed Herein

The surest way to prevent the possibility of terrorists using airline passenger baggage and personal effects as a means of destroying a civilian passenger aircraft in transit is to have all passenger belongings transported in a separate aircraft from the one used to transport the passengers. In this way anything brought to the airport by passengers could not influence the integrity of the passenger compartment or the flight deck. This could be accomplished by having all baggage and passenger's personal items, including in the extreme, clothing and medication, loaded into a separate possibly unmanned craft which would fly to the destination airport at sufficient separation from the passenger craft that if it were to explode it could not damage the craft containing people.

In the absence of cargo, and the consequent redundancy of a cargo deck or space, passenger craft could be optimized for people space. One such configuration could be two or three tiers of passenger cabins.

The fact that baggage would no longer be a source of human danger during air passage would allow the virtual elimination of baggage screening at airports, and thereby remove much of the delays and congestion associated now with checking-in. The result would be an increase in the productive time of travelers.

### DESCRIPTION OF A PREFERRED PROCEDURE

### Operation of Invention

The following description of the method advocated is the procedure whereby the ultimate level of certainty of safety would be achieved; to settle for a lower level of certainty, and an attendant lower level of passenger inconvenience and involvement, the use of transit suits might be foregone.

Passengers would arrive at the airport in the normal manner and check-in their packed luggage. Having received their boarding pass, and when they were ready, they would go to security clearance and give up their hand luggage. They would then be directed to a changing room to exchange their street cloths for a transit suit. Their personal clothing and hand luggage would be taken by airport staff and placed, together with their checked-in luggage, in a security box specifically assigned to them. They would then be free to board the aircraft from a holding lounge.

The passenger aircraft and the cargo craft, preferably an unmanned drone, would be assigned the same flight plan so as to minimize changes to control tower operations, and timing between takeoff and landings otherwise required for separate aircraft.

While specific embodiments of the invention have been described and illustrated, such embodiments should be considered illustrative of the invention only, and not as limiting the invention as construed in accordance with the accompanying claims.

I claim:

1. A method to eliminate the risk of terrorists using passenger airline luggage or carry-on items to destroy a civilian passenger aircraft in transit, by transporting the passengers' baggage and belongings to their destination in an entirely separate cargo aircraft from that in which the passengers are carried.

2. A method to eliminate the risk of terrorists using passenger airline luggage or carry-on items to destroy a civilian passenger aircraft in transit, by employing two separate aircraft, one to carry only passengers, the other to carry all passenger baggage and belongings; the two craft flying a minimal time interval apart.

3. A method to eliminate the risk of terrorists using passenger airline luggage or carry-on items to destroy a civilian passenger aircraft in transit, by employing two separate aircraft flying on the same flight plan, one to carry only passengers, the other a pilotless drone to carry all passenger baggage and belongings.
